(19) United States
(12) Patent Application Publication
(10) Pub. No.: US 2002/0043056 A1
(43) Pub. Date: Apr. 18, 2002

(54) Device for filtering pigment particles from used vaporised paint sprayed from a spray gun

(75) Inventor: Charles Cheng, Feng-Yuan City (TW)

Correspondence Address: LADAS & PARRY, 26 West 61st Street, New York, NY, 10023-7604, US

(73) Assignee: SAN FORD MACHINERY CO., LTD.

(21) Appl. No.: 09/860,121

(22) Filed: May 17, 2001

(30) Foreign Application Priority Data
Oct. 16, 2000 (TW) 89217880

(51) Int. Cl. B01D 46/00

(52) U.S. Cl. 55/385.1; 55/385.2; 55/467; 55/482

(57) ABSTRACT

A device for filtering pigment particles from used vaporized paint sprayed from a spray gun, includes a hood member which is mounted on a supporter and which confines an operating space with an inlet for entrance of the used vaporized paint. A tubular coupling member is connected to the hood member, and has a duct communicated with the inlet. A filtering member is disposed in the duct and downstream of the inlet. A motor-driven impeller is disposed upstream of an outlet of the duct and forces the filtered vaporized paint through the filtering member out of the outlet.

### CROSS-REFERENCE TO RELATED APPLICATION

This application claims priority of Taiwan patent Application No. 089217880, filed on Oct. 16, 2000.

### BACKGROUND OF THE INVENTION

1. Field of the Invention

This invention relates to a device for a spray gun-painting operation, more particularly to a device for filtering pigment particles from used vaporized paint sprayed from the spray gun.

2. Description of the Related Art

A conventional painting operation using a spray gun may generally result in a lot of used vaporized paint in the operating space, and may adversely affect the operator's health.

### SUMMARY OF THE INVENTION

The object of the present invention is to provide a device for filtering pigment particles from used vaporized paint sprayed from a spray gun so as to be suitable for household use.

According to this invention, the device includes a supporter which has an upper platform portion, and a lower leg portion that extends downwardly from the upper platform portion and that is provided with a caster for rolling on the ground. A hood member is supported on the upper platform portion, and includes two lateral hood plates and a top hood plate. The lateral hood plates are spaced apart from each other in a longitudinal direction. Each lateral hood plate has a rear edge which extends in a first direction transverse to the longitudinal direction, and a plate portion which extends forwardly from the rear edge and which extends in the first direction upwardly to terminate at an upper end edge. The top hood plate has two lateral end edges which are disposed opposite to each other in the longitudinal direction and which are connected respectively to the upper end edges of the lateral hood plates so as to cooperate with the lateral hood plates to confine an operating space, and a rear end edge with two ends which are opposite to each other in the longitudinal direction and which are joined with the lateral end edges, respectively. The operating space has an inlet which is confined by the rear edges of the lateral hood plates and the rear end edge of the top hood plate for entrance of used vaporized paint. A tubular coupling member has a front surrounding wall which is connected to the rear edges of the lateral hood plates and the rear end edge of the top hood plate, and a rear surrounding wall which is supported on the upper platform portion and which extends rearwardly and in a second direction transverse to the longitudinal and the first directions from the front surrounding wall to define a duct. The rear surrounding wall has an outlet which is communicated with and downstream of the duct. A filtering member is disposed downstream of the inlet, and has a major wall which is oriented to be normal to the second direction to intersect the duct. A motor-driven impeller is disposed upstream of the outlet and downstream of the filtering member, and is configured so as to force the filtered vaporized paint out of the outlet.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is an exploded perspective view of a preferred embodiment of a filtering device according to this invention;

FIG. 2 is a perspective view of the preferred embodiment;

FIG. 3 is a side view of the preferred embodiment; and

FIG. 4 is a side schematic view illustrating how the used vaporized paint passes through the device of the preferred embodiment.

### DETAILED DESCRIPTION OF THE PREFERRED EMBODIMENT

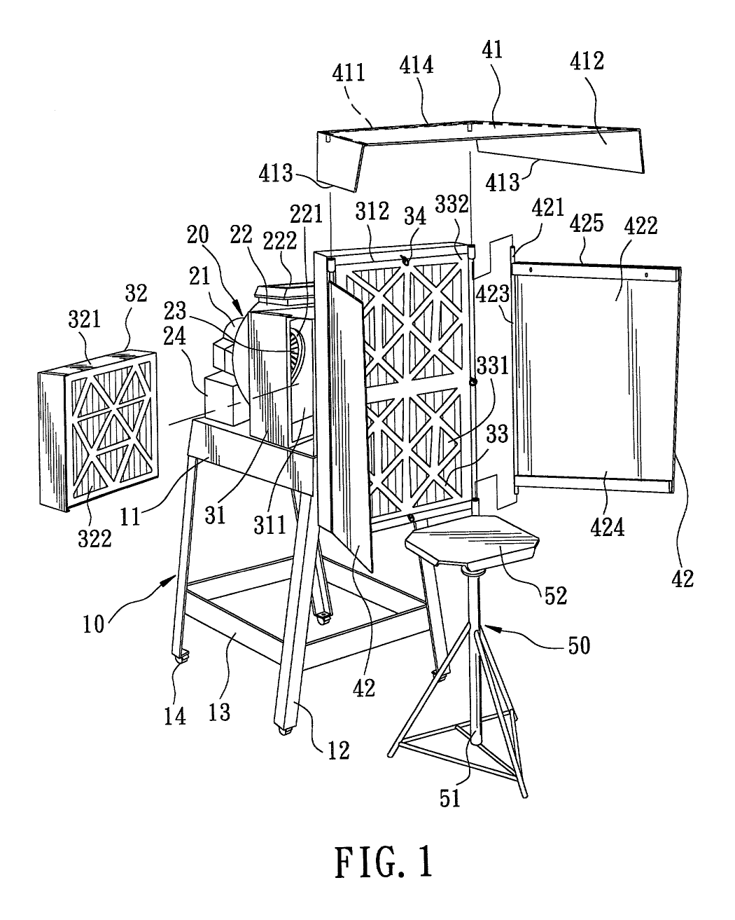

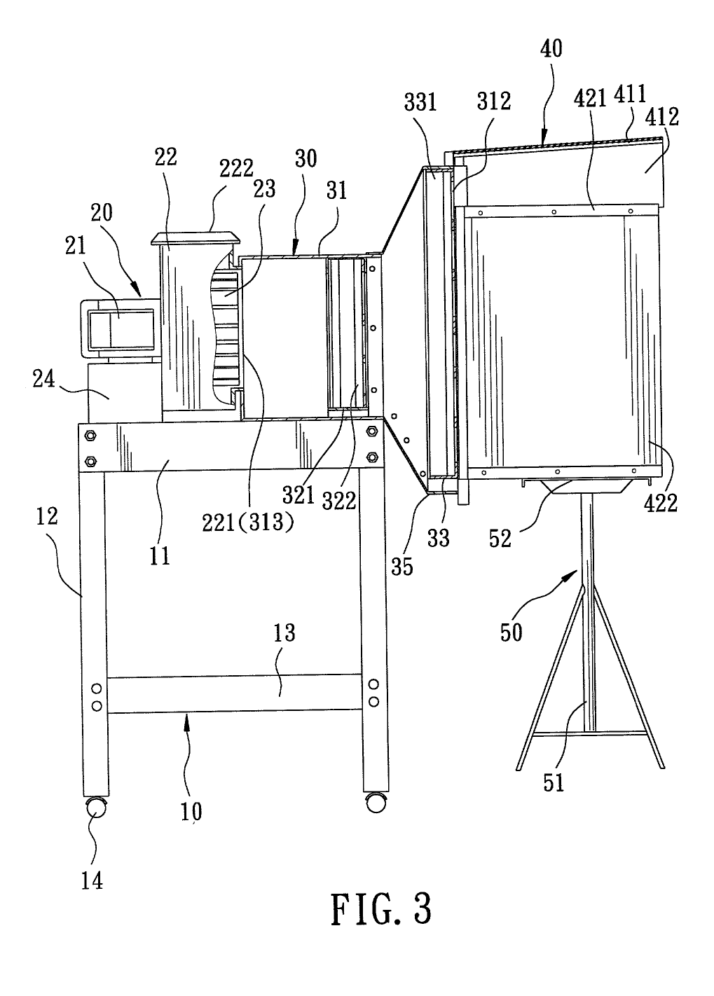

Referring to FIGS. 1, 2 and 3, the preferred embodiment of the filtering device according to the present invention is shown to comprise a supporter 10, a hood member 40, a tubular coupling member 30, a filtering member, and a motor-driven impeller assembly 20.

The supporter 10 has an upper platform portion 11, and a lower leg portion which includes four legs 12 that extend downwardly from the upper platform portion 11 and that are provided with four casters 14 for rolling on the ground, and four transverse rods 13 each of which is interposed between and interconnects two adjacent legs 12.

The hood member 40 is supported on the upper platform portion 11 of the supporter 10, and includes two lateral hood plates 42 and a top hood plate 41. Each hood plate 42,41 includes a frame 421,411 and a panel 422,412. Further, the lateral hood plates 42 are spaced apart from each other in a longitudinal direction. Each lateral hood plate 42 has a rear edge 423 which extends in a first direction transverse to the longitudinal direction, and a plate portion 424 which extends forwardly from the rear edge 423 and which extends in the first direction upwardly to terminate at an upper end edge 425. The top hood plate 41 has two lateral end edges 413 which are disposed opposite to each other in the longitudinal direction and which are connected respectively to the upper end edges 425 of the lateral hood plates 42 so as to cooperate with the lateral hood plates 42 to confine an operating space 6, and a rear end edge 414 with two ends opposite to each other in the longitudinal direction. The rear end edges 414 are joined with the lateral end edges 413, respectively. The operating space 6 has an inlet 312 which is confined by the rear edges 423 of the lateral hood plates 42 and the rear end edge 414 of the top hood plate 41 for entrance of used vaporized paint.

The tubular coupling member 30 has a front surrounding wall 35 which is connected to the rear edges 423 of the lateral hood plates 42 and the rear end edge 414 of the top hood plate 41, a rear surrounding wall 31 which is supported on the upper platform portion 11 and which extends rearwardly and in a second direction transverse to the longitudinal and the first directions from the front surrounding wall 35 to define a duct 311. Preferably, the front surrounding wall 35 converges from the inlet 312 to the rear surrounding wall 31 in the second direction. The rear surrounding wall 31 has an opening 313 which is communicated with and downstream of the duct 311.

The filtering member includes first and second filtering units 33,32. The first filtering unit 33 has a first frame portion 332 with an upper wall edge and two side wall edges that are detachably connected to the rear end edge 414 of the top hood plate 41 and the rear edges 423 of the lateral hood plates 42, respectively. A first filtering mesh portion 331 is enclosed by and is secured on the first frame portion 332 by fasteners 34, and has a major wall that is oriented to be normal to the second transverse direction to intersect the inlet 312. The second filtering unit 32 has a second frame portion 321 which is disposed between the front and rear surrounding walls 35,31, and a second filtering mesh portion 322 which is enclosed by the second frame portion 321 and which is oriented to be normal to the second direction to intersect the duct 311. In this embodiment, each of the first and second mesh portions 331,322 is formed from an active carbon impregnated non-woven fiber. Preferably, the second filtering unit 32 is removable from the tubular coupling member 30 laterally for facilitating replacement.

The motor-driven impeller assembly 20 is mounted on the upper platform portion 11 of the supporter 10 rearwardly of the tubular coupling member 30, and includes a motor 21, a shielding member 22, and an impeller 23. The motor 21 is held by a motor support 24 which is secured on the upper platform portion 11. The shielding member 22 has an inlet 221 which is communicated with the opening 313 of the tubular coupling member 30, and an outlet 222 at an upper end thereof. The impeller 23 is received in the shielding member 23, and is driven by the motor 21 so as to force the filtered vaporized paint through the first and second filtering units 33,32 out of the outlet 222.

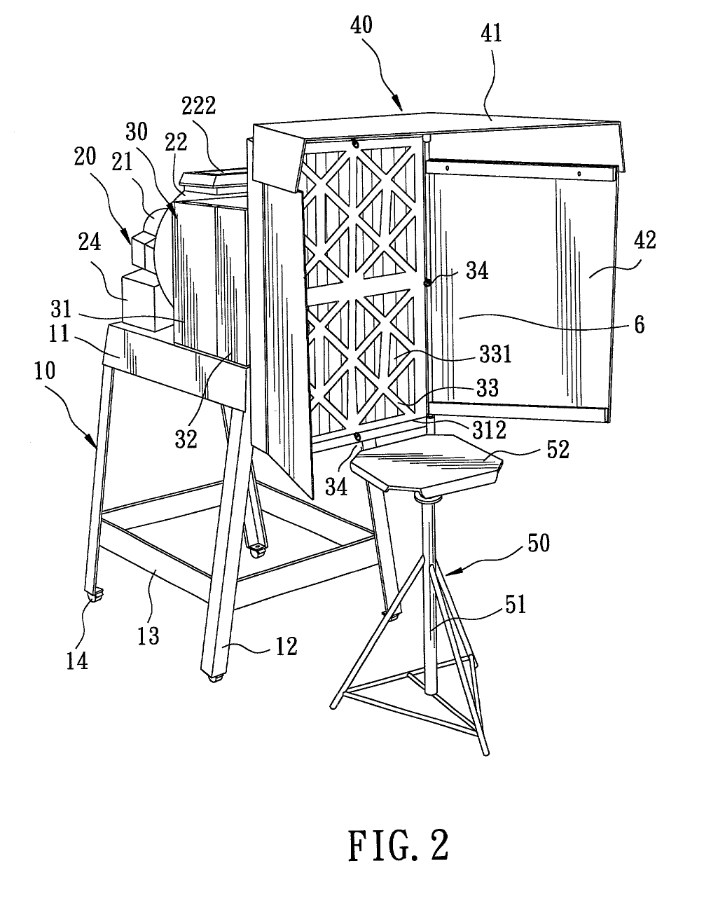

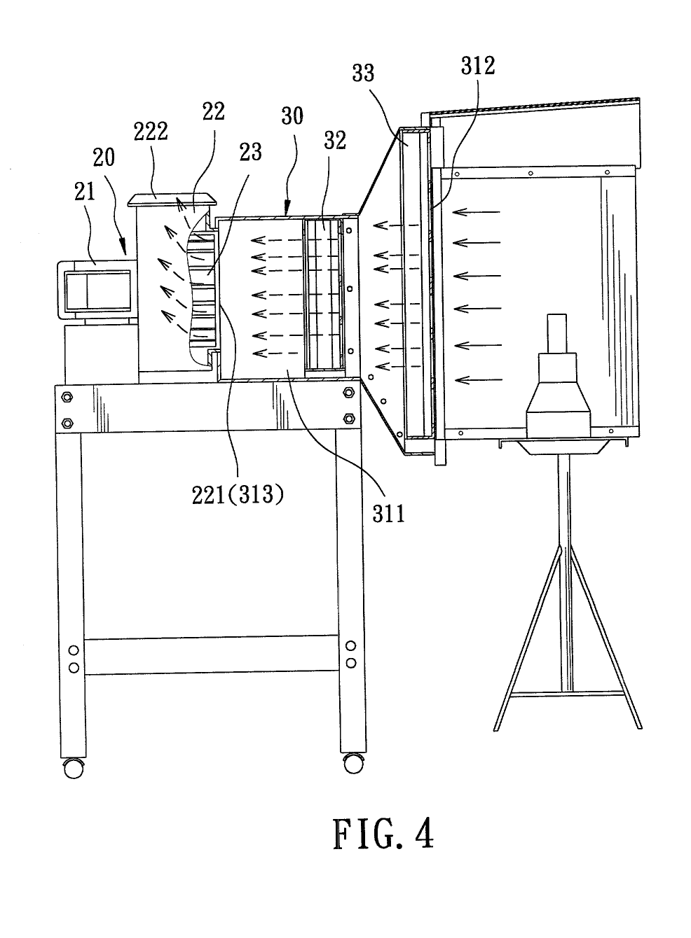

During use, as shown in FIGS. 2 and 4, a workpiece supporting member 50 may be placed in the operating space 6 forwardly of the inlet 312. The supporting member 50 includes a leg portion 51 and a workpiece platform 52 which is rotatably mounted on the leg portion 51 such that a workpiece (not shown) may be placed thereon. By virtue of the motor-driven impeller assembly 20, the used vaporized paint sprayed from a spray gun can flow into the duct 311 from the inlet 312 through the first and second filtering units 33,32. The filtered vaporized paint, which has odors and pigment thereof removed by the filtering member, is then discharged from the outlet 222. In addition, due to the separable structure, the device of this invention can be easily stored and conveniently transported, thereby facilitating household use of the same.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A device for filtering pigment particles from used vaporized paint sprayed from a spray gun, said device comprising:
a supporter having an upper platform portion, and a lower leg portion extending downwardly from said upper platform portion and provided with a caster for rolling on the ground;
a hood member supported on said upper platform portion, and including
two lateral hood plates spaced apart from each other in a longitudinal direction, and each having a rear edge which extends in a first direction transverse to the longitudinal direction, and a plate portion which extends forwardly from said rear edge and which extends in the first direction upwardly to terminate at an upper end edge, and
a top hood plate having two lateral end edges opposite to each other in the longitudinal direction and connected respectively to said upper end edges of said lateral hood plates so as to cooperate with said lateral hood plates to confine an operating space, and a rear end edge with two ends opposite to each other in the longitudinal direction and joined with said lateral end edges respectively, said operating space having an inlet for entrance of the used vaporized paint, said inlet being confined by said rear edges of said lateral hood plates and said rear end edge of said top hood plate;
a tubular coupling member having a front surrounding wall which is connected to said rear edges of said lateral hood plates and said rear end edge of said top hood plate, and a rear surrounding wall which is supported on said upper platform portion and which extends rearwardly and in a second direction transverse to the longitudinal and the first directions from said front surrounding wall to define a duct, said rear surrounding wall having an outlet which is communicated with and downstream of said duct;
a filtering member disposed downstream of said inlet, and having a major wall which is oriented to be normal to the second direction to intersect said duct; and
a motor-driven impeller disposed upstream of said outlet and downstream of said filtering member, and configured so as to force the filtered vaporized paint out of said outlet.

2. The device of claim 1, wherein said filtering member includes a first filtering unit which has a first frame portion with an upper wall edge and two side wall edges that are connected to said rear end edge of said top hood plate and said rear edges of said lateral hood plates respectively, and a first filtering mesh portion enclosed by said first frame portion and oriented to be normal to the second direction to intersect said inlet.

3. The device of claim 2, wherein said filtering member further includes a second filtering unit which has a second frame portion disposed in said tubular coupling member between said first filtering member and said impeller, and a second filtering mesh portion enclosed by said second frame portion and oriented to be normal to the second direction to intersect said duct.

4. The device of claim 3, wherein each of said first and second mesh portions is formed from an active carbon impregnated non-woven fiber.

5. The device of claim 2, wherein said first frame portion is detachably connected to said hood member.

6. The device of claim 3, wherein said second frame portion is detachably mounted in said tubular coupling member.

7. The device of claim 1, wherein said front surrounding wall converges from said inlet to said rear surrounding wall in the second direction.
